(19) United States
(12) Patent Application Publication
(10) Pub. No.: US 2025/0147365 A1
(43) Pub. Date: May 8, 2025

(54) LIQUID CRYSTAL PANEL

(71) Applicant: Japan Display Inc., Tokyo (JP)

(72) Inventors: Shunichi KIMURA, Tokyo (JP); Toshiharu MATSUSHIMA, Tokyo (JP); Yuji MAEDE, Tokyo (JP)

(21) Appl. No.: 18/937,300

(22) Filed: Nov. 5, 2024

(30) Foreign Application Priority Data
Nov. 7, 2023 (JP) 2023-190167

(51) Int. Cl. G02F 1/1343

(52) U.S. Cl. CPC G02F 1/134309

(57) ABSTRACT

A liquid crystal panel includes two substrates and a liquid crystal between the two substrates. A first substrate as one of the two substrates includes: a potential gradient forming section having an outer periphery edge having a circular shape; a first electrode provided on an inner periphery side of the potential gradient forming section; a second electrode provided on an outer periphery side of the potential gradient forming section and having a ring-like shape; a first transmission section provided with a potential; a second transmission section provided with another potential; a first contact coupling the first electrode and the first transmission section; and a second contact coupling the second electrode and the second transmission section. The potential gradient forming section is made of a conductor having an electrical resistance higher than those of the first and second electrodes. A plurality of the second contacts are provided for the second electrode.

### CROSS-REFERENCE TO RELATED APPLICATION

This application claims the benefit of priority from Japanese Patent Application No. 2023-190167 filed on Nov. 7, 2023, the entire contents of which are incorporated herein by reference.

### BACKGROUND

### 1. Technical Field

What is disclosed herein relates to a liquid crystal panel.

### 2. Description of the Related Art

Liquid crystal panels are known that can control orientation of liquid crystal molecules to cause the liquid crystal panels to provide an optical effect such as a lens. Such a liquid crystal panel is disclosed in Japanese Patent Application Laid-open Publication No. 2022-167026.

In order to cause the liquid crystal panel to function as a lens, it is necessary to form a potential gradient by setting a potential difference between inner and outer periphery sides of an electrode having a circular or a ring-like shape in a light-transmitting region of the liquid crystal panel. The circumferential length on the outer periphery side of the electrode is longer than that on the inner periphery side thereof. When a potential is applied from a single point on the circumference on the outer periphery side of the electrode, the farther the position is from the point in the circumferential direction, the less potential is transmitted, resulting in the potential gradient based on the potential difference between the inner and outer periphery sides being not fully formed in some cases.

For the foregoing reasons, there is a need for a liquid crystal panel that can more reliably form a potential gradient based on a potential difference between the inner and outer periphery sides of an electrode.

### SUMMARY

According to an aspect, a liquid crystal panel includes: two substrates; and a liquid crystal interposed between the two substrates. A first substrate that is one of the two substrates includes: a potential gradient forming section that is provided in a light-transmitting region and has an outer periphery edge having a circular shape; a first electrode that is provided on an inner periphery side of the potential gradient forming section; a second electrode that is provided on an outer periphery side of the potential gradient forming section and has a ring-like shape; a first transmission section to which one of two different potentials is applied; a second transmission section to which the other of the two different potentials is applied; a first contact that couples the first electrode and the first transmission section; and a second contact that couples the second electrode and the second transmission section. The potential gradient forming section is made of a conductor having an electrical resistance higher than electrical resistances of the first electrode and the second electrode. A plurality of the second contacts are provided for the second electrode.

### BRIEF DESCRIPTION OF THE DRAWINGS

FIG. 1 is a schematic view illustrating an optical device in an embodiment;

FIG. 2 is a diagram illustrating a schematic structure in a light-transmitting region in a plan view;

FIG. 3 is a III-III line sectional view in FIG. 2;

FIG. 4 is a graph illustrating a relation between a distance from an optical center to a first region, a second region, or a third region, and a refractive index difference of light caused by a liquid crystal in the state illustrated in FIG. 3 in the first region, the second region, and the third region;

FIG. 5 is a schematic diagram illustrating an example of the shapes of a first potential line and a second potential line, and the arrangement of contacts included in a contact layer in the plan view;

FIG. 6 is a sectional view along a dashed line VI illustrated in FIG. 5;

FIG. 7 is a sectional view along a dashed line VII illustrated in FIG. 5;

FIG. 8 is a sectional view along a dashed line VIII illustrated in FIG. 5;

FIG. 9 is a sectional view along a dashed line IX illustrated in FIG. 5;

FIG. 10 is a schematic diagram illustrating an example of the first potential line including branches the number of which is larger than those illustrated in FIG. 5;

FIG. 11 is a schematic diagram illustrating an example of the second potential line including the branches the number of which is larger than those illustrated in FIG. 5;

FIG. 12 is a diagram illustrating a partial exemplary structure of the first potential line and the second potential line when two straight extensions are provided for each arc-shaped extension;

FIG. 13 is a schematic diagram illustrating a structure in which different potentials are applied to a high-resistance film that has a ring-like shape and is provided with a first electrode on the inner periphery side and a second electrode on the outer periphery side, from a single contact point on each of the inner and outer periphery sides; and

FIG. 14 is a schematic diagram illustrating the high-resistance film illustrated in FIG. 13 in the configuration cut at a cutting position CP and unfolded linearly.

### DETAILED DESCRIPTION

An embodiment of the present disclosure is described below with reference to the drawings. What is disclosed herein is only an example, and any modification that can be easily conceived by those skilled in the art while maintaining the main purpose of the invention are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

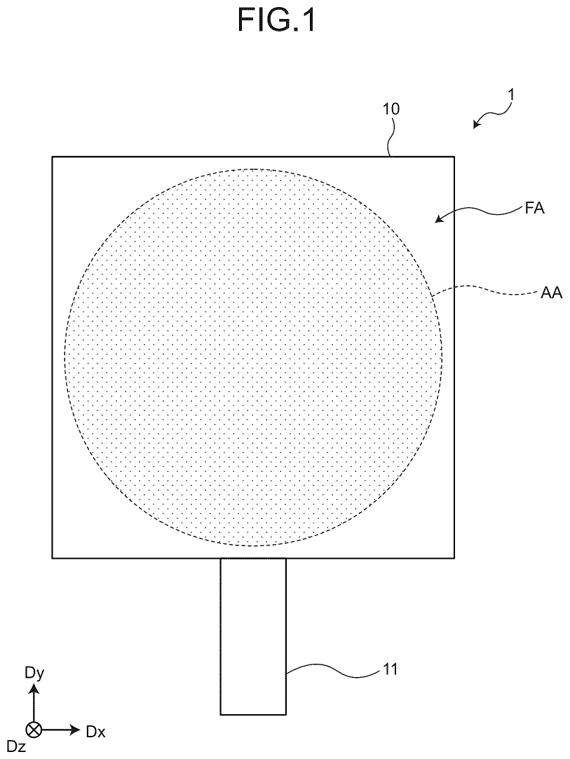

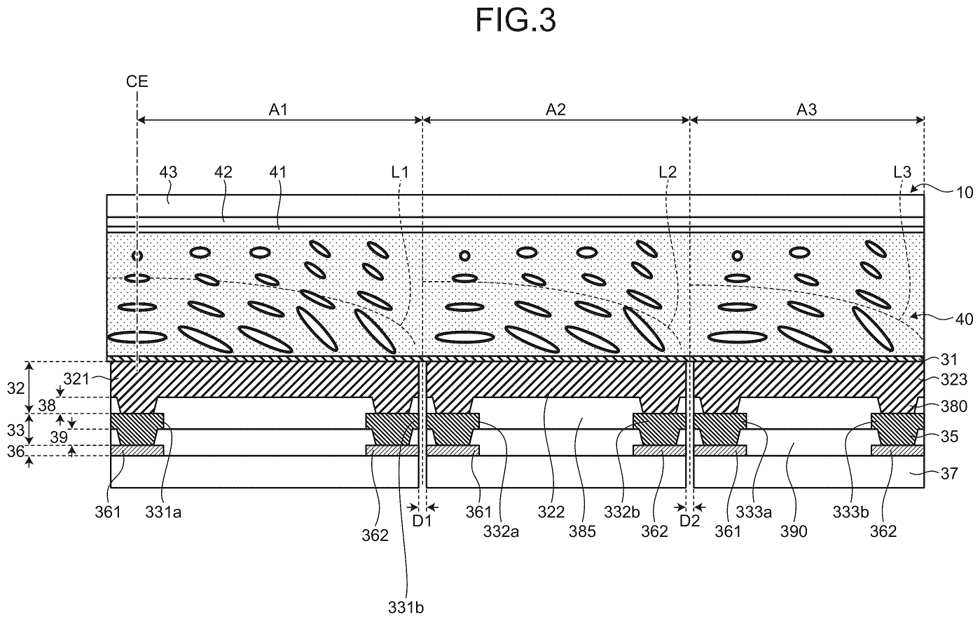

FIG. 1 is a schematic view illustrating an optical device 1 in an embodiment. The optical device 1 includes a liquid crystal panel 10 and a flexible substrate 11. The liquid crystal panel 10 includes a liquid crystal 40 (refer to FIG. 3) enclosed therein. The flexible substrate 11 has a plurality of pieces of wiring that couples the liquid crystal panel 10 to an external control device.

In the following descriptions of the embodiment, a first direction Dx refers to one direction that is along a plate surface of the liquid crystal panel 10. A second direction Dy refers to one direction that is along the plate surface of the liquid crystal panel 10 and orthogonal to the first direction Dx. A third direction Dz refers to one direction that is orthogonal to the first direction Dx and the second direction Dy.

As illustrated in FIG. 1, the liquid crystal panel 10 includes a light-transmitting region AA and a peripheral region FA. The light-transmitting region AA is a region having a circular edge in a plan view. The peripheral region FA surrounds the edge of the light-transmitting region AA in the plan view. The plan view is a view in which the plate surface of the liquid crystal panel 10 is viewed from a viewpoint in front of the plate surface. The light-transmitting region AA is controlled such that the light-transmitting region AA transmits light traveling from one surface side to the other surface side of the liquid crystal panel 10 when the optical device 1 operates. The peripheral region FA is provided such that the peripheral region FA does not transmit light.

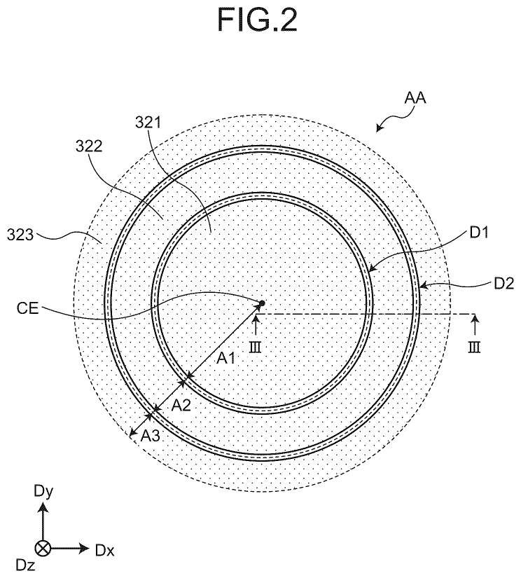

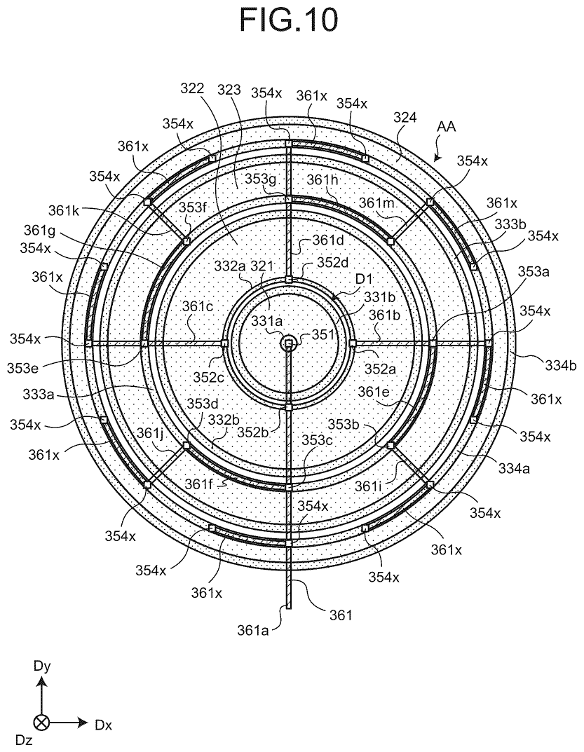

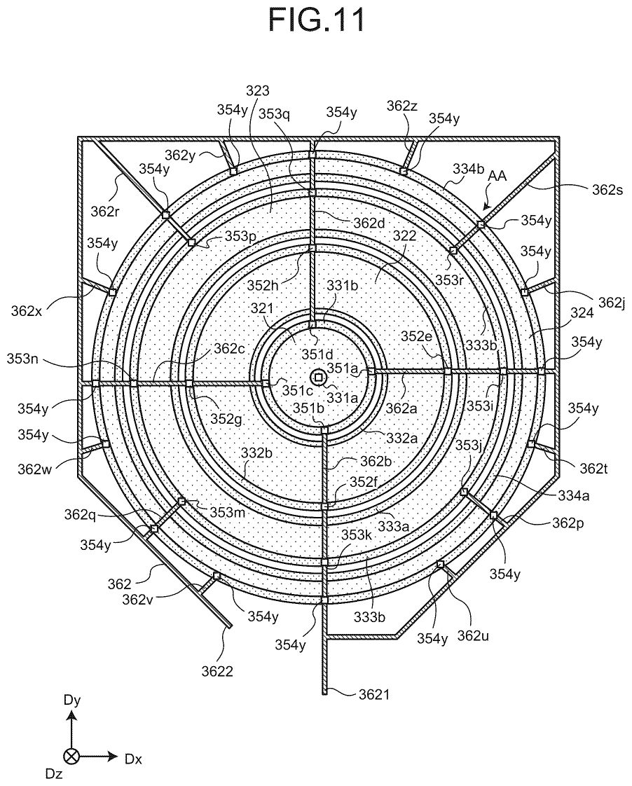

FIG. 2 is a diagram illustrating a schematic structure in the light-transmitting region AA in the plan view. The light-transmitting region AA has a plurality of concentric circular regions having the center of the light-transmitting region AA in common. FIG. 2 illustrates an example of three concentric circular regions: a first region A1, a second region A2, and a third region A3, but this is merely one example. The number of concentric circular regions may be two, or four or more (refer to FIGS. 10 and 11). The concentric circular regions include the first region A1, which is a circular region located at the center, and one or more ring-shaped regions (e.g., the second region A2, the third region A3, etc.) that surround the outer edge of the circular region of the light-transmitting region AA and are provided outside the light-transmitting region AA in a radial direction. Hereafter, when simply referring to the radial direction, it refers to the radial direction of the circle of the light-transmitting region AA, unless otherwise noted. When simply referring to the concentric circular region, it refers to either the circular region or the ring-shaped region.

FIG. 3 is a III-III line sectional view in FIG. 2. As illustrated in FIG. 3, the liquid crystal panel 10 has a first substrate 37 and a second substrate 43 that face in the third direction Dz with the liquid crystal 40 therebetween. The first substrate 37 and the second substrate 43 are light-transmitting substrates such as glass substrates.

On the liquid crystal 40 side of the second substrate 43, an orientation film 41, and a common electrode 42 are stacked in this order from the liquid crystal 40 side to the second substrate 43 side. The orientation film 41 is an insulating layer having grooves formed on the surface on the liquid crystal 40 side. The grooves define the initial orientation of the liquid crystal molecules contained in the liquid crystal 40. The common electrode 42 is an electrode that covers the entire light-transmitting region AA.

On the liquid crystal 40 side of the first substrate 37, an orientation film 31, a high-resistance film layer 32, an electrode layer 33, and a transmission section layer 36 are stacked in this order from the liquid crystal 40 side to the first substrate 37 side. The orientation film 31 is an insulating layer having grooves formed on the surface on the liquid crystal 40 side. The grooves define the initial orientation of the liquid crystal molecules contained in the liquid crystal 40. The high-resistance film layer 32, which has an electrical resistance relatively higher than those of the common electrode 42 and the electrode layer 33, is a film-shaped layer (high-resistance film) that functions as a conductor.

Specifically, the high-resistance film layer 32 is formed of indium tin oxide (ITO) or SiO₂. A specific example of the electrical resistance of the high-resistance film layer 32 is in a range from 106 Ω/m² to 108 Ω/m².

The high-resistance film layer 32 is provided in each concentric circular regions. For example, as illustrated in FIGS. 2 and 3, the high-resistance film layer 32 includes a first high-resistance film 321 provided in the first region A1, a second high-resistance film 322 provided in the second region A2, and a third high-resistance film 323 provided in the third region A3. The circles of the outer periphery edges of first region A1, the second region A2, and the third region A3 have the same center at the center CE. The first region A1, the second region A2, and the third region A3 are the concentric circular regions that have the common center of the circle of the outer periphery edge. As illustrated in FIG. 2, the first high-resistance film 321 has a circular shape in the plan view.

The second high-resistance film 322 has a ring-like shape surrounding the first high-resistance film 321. The third high-resistance film 323 has a ring-like shape surrounding the second high-resistance film 322.

A gap is provided between the concentric circular regions adjacent in the radial direction. FIGS. 2 and 3 exemplify a gap D1 between the first region A1 and the second region A2, and a gap D2 between the second region A2 and the third region A3. The number of gaps is a number obtained by subtracting 1 from the number of concentric circular regions. The gaps are provided to the high-resistance film layer 32 and the electrode layer 33.

In the embodiment, among the concentric circular regions, the outer concentric circular region has a smaller width in the radial direction. According to the widths of these concentric circular regions, among the high-resistance films of the high-resistance film layer 32, the high-resistance film located in the outer concentric circular region has a smaller width in the radial direction.

The electrode layer 33, which has a film-like shape, functions as a conductor. Specifically, the electrode layer 33 and the common electrode 42 are formed of a light-transmitting conductive film having a thin-film-like shape of a material such as ITO or indium zinc oxide (IZO). The electrode layer 33 and the common electrode 42 may be made of a non-light-transmitting material having an extremely high conductivity, such as copper or aluminum.

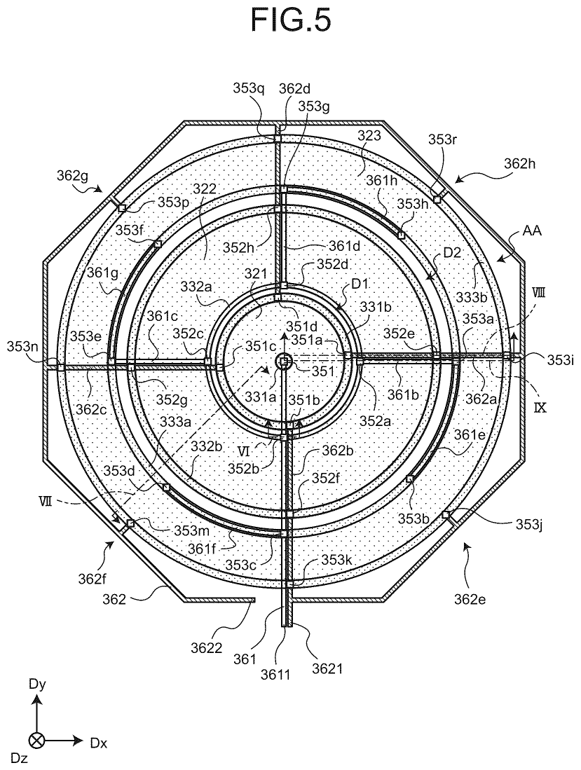

As illustrated in FIG. 3 and FIG. 5, which is described, the electrode layer 33 includes first electrodes 331a, 332a, and 333a, and second electrodes 331b, 332b, and 333b. The first electrode 331a is provided overlapping with the center CE of the first high-resistance film 321 (refer to FIG. 5). The shape of the first electrode 331a in the plan view is circular. The shape may be point-like or polygonal, for example.

The second electrode 331b is provided along the outer periphery edge of the first high-resistance film 321 in an area overlapping with the first high-resistance film 321. The first electrode 332a is provided along the inner periphery edge of the second high-resistance film 322 in an area overlapping with the second high-resistance film 322. The second electrode 332b is provided along the outer periphery edge of the second high-resistance film 322 in an area overlapping with the second high-resistance film 322. The first electrode 333a is provided along the inner periphery edge of the third high-resistance film 323 in an area overlapping with the third high-resistance film 323. The second electrode 333b is provided along the outer periphery edge of the third high-resistance film 323 in an area overlapping with the third high-resistance film 323. As illustrated in FIG. 5, the shapes of the second electrode 331b, the first electrode 332a, the second electrode 332b, the first electrode 333a, and the second electrode 333b in the plan view are each a full circular ring.

As illustrated in FIGS. 3 and 5, the first electrode 331a and the second electrode 331b are separated in the radial direction. The first electrode 332a and the second electrode 332b are separated in the radial direction. The first electrode 333a and the second electrode 333b are separated in the radial direction.

The high-resistance film layer 32 and the electrode layer 33 are coupled via contacts formed at the positions where the high-resistance film layer 32 and the electrode layer 33 overlap. FIG. 3 exemplifies a contact 380 that couples the third high-resistance film 323 and the second electrode 333b. The contact 380 is formed in a coupling section layer 38. The coupling section layer 38 is part of the high-resistance film layer 32 and is located on the electrode layer 33 side of the high-resistance film layer 32.

In the embodiment, among the contacts formed at the positions where the high-resistance film layer 32 and the electrode layer 33 overlap, only the contact coupling the first high-resistance film 321 and the first electrode 331a has a point-like shape, while the other contacts have a full circular ring shape.

The transmission section layer 36 is a conductive layer that overlaps with part of the electrode layer 33 in the plan view. The transmission section layer 36 is formed of a material having an extremely high conductivity, such as copper or aluminum.

The transmission section layer 36 includes a first potential line 361 and a second potential line 362. The first potential line 361 overlaps with part of the structures provided on the inner periphery sides of the concentric circular regions of the electrode layer 33. Specifically, as illustrated in FIG. 3, the first potential line 361 overlaps with the first electrodes 331a, 332a, and 333a. The second potential line 362 overlaps with part of the structures provided on the outer periphery sides of the concentric circular regions of the electrode layer 33. Specifically, as illustrated in FIG. 3, the second potential line 362 overlaps with the second electrodes 331b, 332b, and 333b. The first potential line 361 and the second potential line 362 are coupled to power feeding points of different potentials on the other end sides thereof, which are not illustrated.

The electrode layer 33 and the transmission section layer 36 are coupled via contacts formed at the positions where the electrode layer 33 and the transmission section layer 36 overlap. FIG. 3 exemplifies a contact layer 35 that couples the second electrode 333b and the second potential line 362. The contact layer 35 is formed in a coupling section layer 39. The coupling section layer 39 is part of the electrode layer 33 and is located on the transmission section layer 36 side of the electrode layer 33.

The structure included in the electrode layer 33 and the structure included in the transmission section layer 36 except the combination of the second electrode 333b and the second potential line 362 are also coupled via the contacts. Specifically, the first potential line 361 is coupled to the first electrodes 331a, 332a, and 333a. The second potential line 362 is coupled to the second electrodes 331b, 332b and 333b.

At a position where the electrode layer 33 and the transmission section layer 36 overlap in the plan view but no contacts are provided, no couplings are established.

On the basis of the multilayered structures and the coupling relations described with reference to FIG. 3, a potential difference is generated between the inner side and the outer side in the radial direction of the high-resistance film layer 32. Specifically, the difference between the potential applied to the first potential line 361 and the potential applied to the second potential line 362 produces a potential gradient between the inner side and the outer side in the radial direction of the high resistance film layer 32. This causes the orientations of the liquid crystal molecules in the liquid crystal 40 to be changed to those according to the respective potential gradients in the first region A1, second region A2, and third region A3, as illustrated in FIG. 3. More specifically, the orientations of the liquid crystal molecules are determined by the relation between the electric potential gradients and the constant electric potential applied to the common electrode 42.

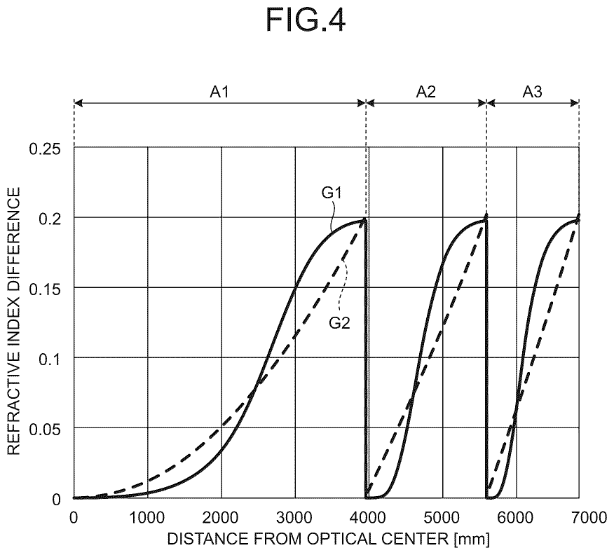

FIG. 4 is a graph illustrating a relation between the distance from the optical center to the first region A1, the second region A2, and the third region A3, or a refractive index difference of light caused by the liquid crystal 40 in the state illustrated in FIG. 3 in the first region A1, the second region A2, and the third region A3. The refractive index difference indicates the magnitude of change in the traveling direction of light incident along the third direction Dz from the first substrate 37 side of the liquid crystal panel 10. The greater the degree of change of the traveling direction of light along the traveling direction while the light passes through the liquid crystal panel 10 until the light reaches the second substrate 43 side, the greater the refractive index difference. The degree of change of the traveling direction of the light refers to the degree to which the traveling direction of the light changes inwardly in the radial direction with the focal point as a center.

In the specific example, as illustrated in the graphs G1 and G2 in FIG. 4, in each of the first region A1, the second region A2, and the third regions A3, the refractive index difference decreases as the distance in the radial direction decreases; while the refractive index difference increases as the distance in the radial direction increases. In the specific example, the refractive index difference is controlled such that the refractive index difference increases from the inner side to the outer side in the radial direction in a single concentric circular region, but at the boundary from one concentric circular region to another, the refractive index difference is reset to zero at the innermost periphery of the other concentric circular region. The refractive index difference in the embodiment is closer to that illustrated in the graph G2.

The potential difference between the potential applied to the first potential line 361 and the potential applied to the second potential line 362 is controlled such that the refractive index difference described with reference to FIG. 4 is established. With this control, in each concentric circular region of the liquid crystal panel 10, the closer to the outer side in the radial direction, the more the region produces an optical effect similar to that of a lens that directs, toward the focal point, light incident along the third direction Dz from the lower side. This optical effect is the same as that of a lens having a convex shape with a flat bottom surface when comparing with the optical effect of a lens as an analogy. FIG. 3 illustrates the dashed lines L1, L2, and L3 in order to schematically indicate this optical effect. The dashed line L1 illustrates the optical effect caused by controlling the orientation of the liquid crystal molecules in the liquid crystal 40 in the first region A1. The dashed line L2 illustrates the optical effect caused by controlling the orientation of the liquid crystal molecules in the liquid crystal 40 in the second region A2. The dashed line L3 illustrates the optical effect caused by controlling the orientation of the liquid crystal molecules in the liquid crystal 40 in the third region A3. The optical effect by the concentric circular regions, as schematically illustrated with the dashed lines L1, L2, and L3, is substantially the same as the optical effect produced by a Fresnel lens. In other words, the liquid crystal panel 10 including the concentric circular regions operates to produce the same optical effect as that of the Fresnel lens.

The following describes the more specific shapes of the first potential line 361 and the second potential line 362 in the plan view, and the arrangement of the contacts included in the contact layer 35 in the plan view with reference to FIGS. 5 to 12.

FIG. 5 is a schematic diagram illustrating an example of the shapes of the first potential line 361 and the second potential line 362, and the arrangement of the contacts included in the contact layer 35 in the plan view. Contacts 351, 351a, 351b, 351c, 351d, 352a, 352b, 352c, 352d, 352e, 352f, 352g, 352h, 353a, 353b, 353c, 353d, 353e, 353f, 353g, 353h, 3531, 353j, 353k, 353m, 353n, 353p, 353q, 353r are included in the contact layer 35 illustrated in FIG. 3, and they each function as the contact.

The first potential line 361 has a base extending along the radial direction from the center of the concentric circular regions to outside the concentric circular regions. In FIG. 5, an end 3611 is the end of the base on the outer side in the radial direction. In FIG. 5, the base is along the second direction Dy. Hereafter, in the description of the first potential line 361, each section is described with reference to the extending direction (the second direction Dy) of the base. An end of the first potential line 361 opposite to the end thereof outside the light-transmitting region AA is coupled to the first electrode 331a in the light-transmitting region AA via the contact 351. The first potential line 361 is thus coupled to the first electrode 331a via a single position (the contact 351).

The first potential line 361 illustrated in FIG. 5 has extensions 361b, 361c, and 361d, and arc-shaped extensions 361e, 361f, 361g, and 361h.

The first electrode 332a is provided with the contacts 352a, 352b, 352c, and 352d as the contacts provided in the contact layer 35. The contact 352b, which corresponds to a contact 352 in the embodiment, overlaps with the first potential line 361 in the plan view, and couples the first electrode 332a and the first potential line 361. The contacts 352a, 352b, 352c, and 352d are arranged such that the circle formed by the first electrode 332a is substantially equally divided into 4 sections.

Specifically, the contacts 352a and 352c are arranged to face each other substantially in the first direction Dx with the first electrode 331a interposed therebetween in the plan view. The contacts 352b and 352d are arranged to face each other substantially in the second direction Dy with the first electrode 331a interposed therebetween in the plan view.

The extension 361b has one end at the position of the contact 352a in the plan view and the other end extending along the first direction Dx to a position overlapping with the first electrode 333a. The extension 361c has one end at the position of the contact 352c in the plan view and the other end extending along the first direction Dx to a position overlapping with the first electrode 333a. The extension 361d has one end at the position of the contact 352d in the plan view and the other end extending along the second direction Dy to a position overlapping with the first electrode 333a.

The arc-shaped extension 361e extends from the other end of the extension 361b in a clockwise direction along the first electrode 333a to form an arc having an arc length of about ⅛ of the circumference of the first electrode 333a. The arc-shaped extension 361f extends, from a position of the first potential line 361 overlapping with the first electrode 333a, in a clockwise direction along the first electrode 333a to form an arc having an arc length of about ⅛ of the circumference of the first electrode 333a. The arc-shaped extension 361g extends from the other end of the extension 361c in a clockwise direction along the first electrode 333a to form an arc having an arc length of about ⅛ of the circumference of the first electrode 333a. The arc-shaped extension 361h extends from the other end of the extension 361d in a clockwise direction along the first electrode 333a to form an arc having an arc length of about ⅛ of the circumference of the first electrode 333a.

The contact 353a couples the first potential line 361 and the first electrode 333a at the position where the contact 353a overlaps with the other end of the extension 361b in the plan view. The contact 353b couples the first potential line 361 and the first electrode 333a at the position where the contact 353b overlaps with the extended end of the arc-shaped extension 361e in the plan view. The contact 353c couples the first potential line 361 and the first electrode 333a at the position where the first potential line 361 overlaps with the first electrode 333a. The contact 353d couples the first potential line 361 and the first electrode 333a at the position where the contact 353d overlaps with the extended end of the arc-shaped extension 361f in the plan view. The contact 353e couples the first potential line 361 and the first electrode 333a at the position where the contact 353e overlaps with the other end of the arc-shaped extension 361g in the plan view. The contact 353f couples the first potential line 361 and the first electrode 333a at the position where the contact 353f overlaps with the extended end of the arc-shaped extension 361g in the plan view. The contact 353g couples the first potential line 361 and the first electrode 333a at the position where the contact 353g overlaps with the other end of the arc-shaped extension 361h in the plan view. The contact 353h couples the first potential line 361 and the first electrode 333a at the position where the contact 353h overlaps with the extended end of the arc-shaped extension 361h in the plan view. The first potential line 361 is, thus, coupled to the first electrode 333a via eight positions (the contacts 353a, 353b, 353c, 353d, 353e, 353f, 353g, and 353h).

The second potential line 362 illustrated in FIG. 5 has a base that has an octagonal shape and surrounds the light-transmitting region AA. One side of the octagon is divided into two parts, and the first potential line 361 is interposed between the two parts. An end 3621 is one end of one of the two parts extending in the first direction Dx. The end 3621 is continuous with an extension 362b, which extends in the second direction Dy. The shape of the base of the second potential line 362 may be any shape that can surround the outer edge of the light-transmitting region AA. The base may have a circular shape, for example. The following explanation is made assuming that the second potential line 362 has an octagonal shape.

The second potential line 362 illustrated in FIG. 5 has extensions 362a, 362b, 362c, 362d, 362e, 362f, 362g, and 362h.

The extensions 362a, 362b, 362c, and 362d each extend from a corresponding one of the sides of the octagonal shape of the second potential line 362 to a position overlapping with the second electrode 331b in the plan view. The extensions 362a and 362c are along the first direction Dx. The extensions 362b and 362d are along the second direction Dy. The side of the first potential line 361 from which the extension 362a extends and the side of the first potential line 361 from which the extension 362c extends face each other with the light-transmitting region AA therebetween. The side of the first potential line 361 from which the extension 362b extends and the side of the first potential line 361 from which the extension 362d extends face each other with the light-transmitting region AA therebetween.

The extension 362a is coupled to the second electrode 331b via the contact 351a at the position where the extended end of the extension 362a overlaps with the second electrode 331b. The extension 362a is coupled to the second electrode 332b via the contact 352e at the position where the extension 362a overlaps with the second electrode 332b. The extension 362a is coupled to the second electrode 333b via the contact 353i at the position where the extension 362a overlaps with the second electrode 333b.

The extension 362b is coupled to the second electrode 331b via the contact 351b at the position where the extended end of the extension 362b overlaps with the second electrode 331b. The extension 362b is coupled to the second electrode 332b via the contact 352f at the position where the extension 362b overlaps with the second electrode 332b. The extension 362b is coupled to the second electrode 333b via the contact 353k at the position where the extension 362b overlaps with the second electrode 333b. The extension 362c is coupled to the second electrode 331b via the contact 351c at the position where the extended end of the extension 362c overlaps with the second electrode 331b. The extension 362c is coupled to the second electrode 332b via the contact 352g at the position where the extension 362c overlaps with the second electrode 332b. The extension 362c is coupled to the second electrode 333b via the contact 353n at the position where the extension 362c overlaps with the second electrode 333b.

The extension 362d is coupled to the second electrode 331b via the contact 351d at the position where the extended end of the extension 362d overlaps with the second electrode 331b. The extension 362d is coupled to the second electrode 332b via the contact 352h at the position where the extension 362d overlaps with the second electrode 332b. The extension 362d is coupled to the second electrode 333b via the contact 353q at the position where the extension 362d overlaps with the second electrode 333b.

The contacts 352a, 352b, 352c, and 352d are arranged on the same circumference in this order in a clockwise direction from the contact 352a serving as a starting point. The contacts 353a, 353b, 353c, 353d, 353e, 353f, 353g, and 353h are arranged on the same circumference in this order in a clockwise direction from the contact 353a serving as a starting point.

The extensions 362e, 362f, 362g, and 362h each extend from a corresponding one of the sides of the octagonal shape of the second potential line 362 to a position overlapping with the second electrode 333b in the plan view.

The side of the second potential line 362 from which the extension 362a extends, the side of the second potential line 362 from which the extension 362b extends, the side of the second potential line 362 from which the extension 362c extends, the side of the second potential line 362 from which the extension 362d extends, the side of the second potential line 362 from which the extension 362e extends, the side of the second potential line 362 from which the extension 362f extends, the side of the second potential line 362 from which the extension 362g extends, and the side of the second potential line 362 from which the extension 362h extends differ from one another.

The extension 362e is coupled to the second electrode 333b via the contact 353j at the position where the extension 362e overlaps with the second electrode 333b. The extension 362f is coupled to the second electrode 333b via the contact 353m at the position where the extension 362f overlaps with the second electrode 333b. The extension 362g is coupled to the second electrode 333b via the contact 353p at the position where the extension 362g overlaps with the second electrode 333b. The extension 362h is coupled to the second electrode 333b via the contact 353r at the position where the extension 362h overlaps with the second electrode 333b.

The contacts 351a, 351b, 351c, and 351d are arranged on the same circumference in this order in a clockwise direction from the contact 351a serving as a starting point. The contacts 352e, 352f, 352g, and 352h are arranged on the same circumference in this order in a clockwise direction from the contact 352e serving as a starting point. The contacts 353i, 353j, 353k, 353m, 353n, 353p, 353q, and 353r are arranged on the same circumference in this order in a clockwise direction from the contact 353i serving as a starting point.

The first potential line 361 is coupled to a first power feeder, which is not illustrated, at the end 3611 outside the light-transmitting region AA. At least one of the ends 3621 and 3622 is coupled to a second power feeder, which is not illustrated, outside the light-transmitting region AA. The ends 3621 and 3622 are the ends of the two parts obtained by dividing the side of the octagonal base into two. The potential applied to the first potential line 361 from the first power feeder and the potential applied to the second potential line 362 from the second power feeder differ. This potential difference produces the potential gradient described with reference to FIG. 4.

The potential difference corresponding to the dashed line L1 illustrated in FIG. 3 is the difference between the potential of the first electrode 331a applied from the first potential line 361 via the contact 351 and the potential of the second electrode 331b applied from the second potential line 362 via the extensions 362a, 362b, 362c, and 362d and the contacts 351a, 351b, 351c, and 351d.

The potential difference corresponding to the dashed line L2 illustrated in FIG. 3 is the difference between the potential of the first electrode 332a applied from the first potential line 361 via the contacts 352a, 352b, 352c, and 352d, and the potential of the second electrode 332b applied from the second potential line 362 via the extensions 362a, 362b, 362c, and 362d and the contacts 352e, 352f, 352g, and 352h.

The potential difference corresponding to the dashed line L3 illustrated in FIG. 3 is the potential difference between the potential of the first electrode 333a applied from the first potential line 361 via the extensions 361b, 361c, and 361d, the arc-shaped extensions 361e, 361f, 361g and 361h, and the contacts 353a, 353b, 353c, 353d, 353e, 353f, 353g, and 353h, and the potential of the second electrode 333b applied from the second potential line 362 via the extensions 362a, 362b, 362c, 362d, 362e, 362f, 362g, and 362h and the contacts 353i, 353j, 353k, 353m, 353n, 353p, 353q, and 353r.

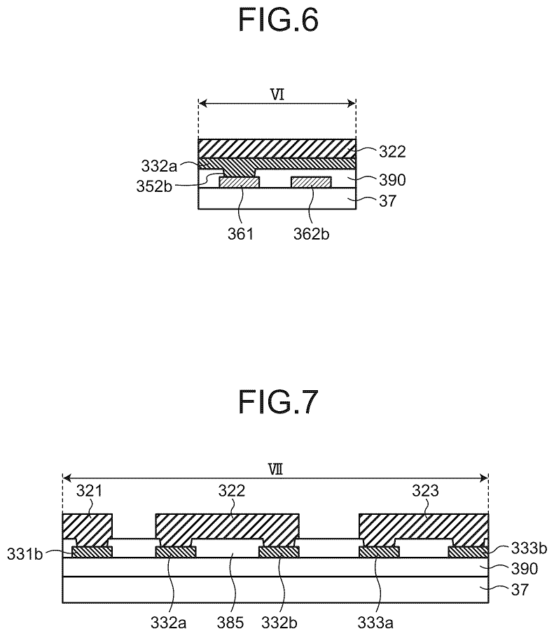

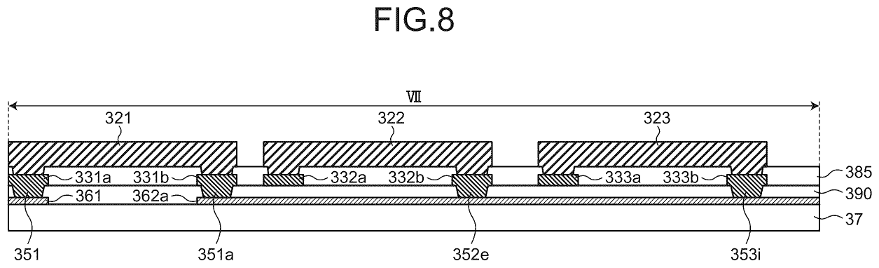

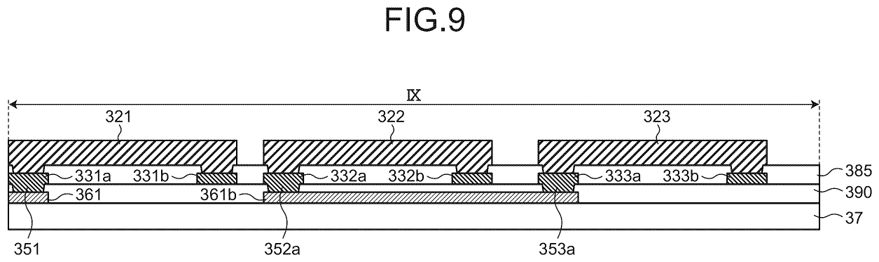

FIG. 6 is a sectional view along a dashed line VI illustrated in FIG. 5. FIG. 7 is a sectional view along a dashed line VII illustrated in FIG. 5. FIG. 8 is a sectional view along a dashed line VIII illustrated in FIG. 5. FIG. 9 is a sectional view along a dashed line IX illustrated in FIG. 5. FIGS. 6 to 9 illustrate only the high-resistance film layer 32 and the layers on the first substrate 37 side of the high-resistance film layer 32; and the other multilayered structures included in the liquid crystal panel 10 are omitted.

The first potential line 361 and the second potential line 362 are in the same layer but electrically independent. For example, as illustrated in FIG. 6, the first potential line 361 and the extension 362b are separated in the first direction Dx. As exemplified in FIGS. 8 and 9, the structure included in the first potential line 361 and the structure included in the second potential line 362 are separated at the other positions.

On the identical circumference where a part of the first potential line 361 (e.g., the arc-shaped extension 361b illustrated in FIG. 9) is coupled to a part of the electrode layer 33 (e.g., the first electrodes 331a, 332a, and 333a illustrated in FIG. 9) via the contact layer 35 (e.g., the contacts 351, 352a, and 353a illustrated in FIG. 9), the second potential line 362 is not coupled to the part of the electrode layer 33. On the identical circumference where a part of the second potential line 362 (e.g., the extension 362a illustrated in FIG. 8) is coupled to a part of the electrode layer 33 (e.g., the second electrode 332b illustrated in FIG. 7) via the contact layer 35 (e.g., the contact 352f illustrated in FIG. 8), the first potential line 361 (e.g., first potential line 361 illustrated in FIG. 7) is not coupled to the part of the electrode layer 33 except the coupling between the first electrode 331a and the first potential line 361 via the contact 351 at the center in the radial direction. These coupling relations are not limited to the positions exemplified in FIGS. 8 and 9. These coupling relations are also established at the other positions in the light-transmitting region AA.

The example of the shapes of the first potential line 361 and the second potential line 362, and the arrangement of the contacts included in the contact layer 35 are described above with reference to FIGS. 5 to 9. The shapes of the first potential line 361 and the second potential line 362, and the arrangement of the contacts in the contact layer 35 are not limited to this example. For example, the number of branches of the first potential line 361 and the second potential line 362 may vary as appropriate depending on the number of concentric circular regions with the center of the light-transmitting region AA as the concentric center. The following describes examples of a configuration in which the number of the branches of the first potential line 361 and the second potential line 362 is larger than those in FIG. 5, with reference to FIGS. 10 to 12.

FIG. 10 is a schematic diagram illustrating an example of the first potential line 361 including the branches the number of which is larger than those illustrated in FIG. 5. FIG. 11 is a schematic diagram illustrating an example of the second potential line 362 including the branches the number of which is larger than those illustrated in FIG. 5. For the purpose of clarity of illustration, the first potential line 361 is illustrated in FIG. 10 while the second potential line 362 is illustrated in FIG. 11. But in reality, the first potential line 361 in FIG. 10 and the second potential line 362 in FIG. 11 are both provided in the same liquid crystal panel 10. In FIGS. 10 and 11, the number of concentric circular regions is four, and a fourth high-resistance film 324 is provided outside the third high-resistance film 323. The fourth high-resistance film 324 is part of the high-resistance film layer 32. A first electrode 334a is provided along the inner periphery edge of the fourth high-resistance film 324. A second electrode 334b is provided along the outer periphery edge of the fourth high-resistance film 324. The first electrode 334a and the second electrode 334b are part of the electrode layer 33 and have a ring-like shape.

The following explanation with reference to FIGS. 10 and 11 focuses specifically on the differences from the structure illustrated in FIG. 5. A plurality of contacts 354x illustrated in FIG. 10 and a plurality of contacts 354y illustrated in FIG. 11 are included in the contact layer 35 illustrated in FIG. 3, and they each function as the contact.

In FIG. 10, the base of the first potential line 361 extends to the outside of the fourth high-resistance film 324. The extensions 361b, 361c, and 361d each have: one end where the contact layer 35 (the contacts 352a, 352b, 352c, and 352d) overlaps with the first electrode 332a; and the other end extending to a position overlapping with the first electrode 334a.

The first potential line 361 illustrated in FIG. 10 has straight extensions 361i, 361j, 361k, and 361m, and a plurality of arc-shaped extensions 361x in addition to the structure included in the first potential line 361 illustrated in FIG. 5. The straight extension 361i extends straight toward the outside of the light-transmitting region AA from the extended end of the arc-shaped extension 361e to a position overlapping with the first electrode 334a. The straight extension 361j extends straight toward the outside of the light-transmitting region AA from the extended end of the arc-shaped extension 361f to a position overlapping with the first electrode 334a. The straight extension 361k extends straight toward the outside of the light-transmitting region AA from the extended end of the arc-shaped extension 361g to a position overlapping with the first electrode 334a. The straight extension 361m extends straight toward the outside of the light-transmitting region AA from the extended end of the arc-shaped extension 361h to a position overlapping with the first electrode 334a.

One of the arc-shaped extensions 361x extends from a position at which the base of the first potential line 361 overlaps with the first electrode 334a in a clockwise direction along the first electrode 334a to form an arc having an arc length of about 1/16 of the circumference of the first electrode 334a. Except the one of the arc-shaped extensions 361x described above, the other arc-shaped extensions 361x each extend from the extended end in the radius direction of a corresponding one of the extensions 361b, 361c, and 361d, and the straight extensions 361i, 361j, 361k, and 361m in a clockwise direction along the first electrode 334a to form an arc having an arc length of about 1/16 of the circumference of the first electrode 334a.

The contacts 354x couple the arc-shaped extensions 361x and the first electrode 334a at positions overlapping with the ends of the arcs of the arc-shaped extensions 361x. In the example illustrated in FIG. 10, the first potential line 361 has 8 arc-shaped extensions 361x and is coupled to the first electrode 334a via the 16 contacts 354x.

The second potential line 362 illustrated in FIG. 11 has a hexagonal shape in the plan view. The shape of the base of the second potential line 362 located to surround the light-transmitting region AA is not limited to an octagonal shape in the plan view. Any shape may be usable that can fit in the peripheral region FA of the liquid crystal panel 10 and can be provided around the light-transmitting region AA.

The extensions 362a, 362b, 362c, and 362d illustrated in FIG. 11 each extend from a corresponding one of the sides of the hexagonal shape of the second potential line 362 to a position overlapping with the second electrode 331b. The extensions 362a, 362b, 362c, and 362d illustrated in FIG. 11 overlap with not only the second electrodes 331b, 332b, and 333b, but also the second electrode 334b in the plan view. The extensions 362a, 362b, 362c, and 362d illustrated in FIG. 11 are each coupled to the second electrode 334b via the contact 354y at a position overlapping with the second electrode 334b. The configuration of FIG. 11 has extensions 362p, 362q, 362r, and 362s coupled to the second electrode 333b via the contacts 353j, 353m, 353p, and 353r whereas the configuration of FIG. 5 has the extensions 362e, 362f, 362g, 362h coupled to the second electrode 333b via the contacts 353j, 353m, 353p, and 353r. The extensions 362p, 362q, 362r, and 362s each extend from a corresponding one of the sides of the hexagonal shape of the second potential line 362 to a position overlapping with the second electrode 333b. The extensions 362p, 362q, 362r, and 362s are each coupled to the second electrode 334b via the contact 354y at the position where the extension overlaps with the second electrode 334b.

The second potential line 362 illustrated in FIG. 11 has extensions 362t, 362u, 362v, 362w, 362x, 362y, 362z, and 362j in addition to the structure of the second potential line 362 illustrated in FIG. 5. The extensions 362t, 362u, 362v, 362w, 362x, 362y, 362z, and 362j each extend from a corresponding one of the sides of the hexagonal shape of the second potential line 362 to a position overlapping with the second electrode 334b. The extensions 362t, 362u, 362v, 362w, 362x, 362y, 362z, and 362j are each coupled to the second electrode 334b via the contact 354y at the position where the extension overlaps with the second electrode 334b.

In the structure in which the extensions extend from the hexagonal second potential line 362 to the light-transmitting region AA as illustrated in FIG. 11, the extensions 362a, 362t, 362p, 362u, 362b, 362v, 362q, 362w, 362c, 362x, 362r, 362y, 362d, 362z, 362s, and 362j are arranged in a clockwise direction in this order from the extension 362a serving as a starting point. In the example illustrated in FIG. 11, the second potential line 362 is coupled to the second electrode 334b via the 16 contacts 354y.

In FIG. 10, the straight extensions that extend from the arc-shaped extension toward the outside of the light-transmitting region AA are arranged, one for each arc-shaped extension. A plurality of straight extensions may be provided for each arc-shaped extension.

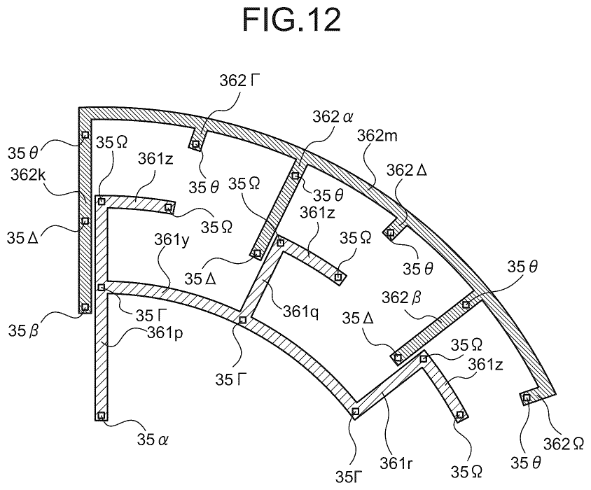

FIG. 12 is a diagram illustrating a partial exemplary structure of the first potential line 361 and the second potential line 362 when two straight extensions are provided for each arc-shaped extension. A straight section 361p in FIG. 12 corresponds to the base of the extension 361b, 361c, or 361d, or the first potential line 361 in FIG. 10. An arc-shaped extension 361y in FIG. 12 corresponds to the arc-shaped extensions 361e, 361f, 361g, or 361h in FIG. 10. Contacts 35x, 353, 351, 354, 352, and 350 in FIG. 12 are included in the contact layer 35 illustrated in FIG. 3, and each function as the contact.

As illustrated in FIG. 12, a straight extension 361r extends straight toward the outside of the arc-shaped portion of the arc-shaped extension 361y from an end of the arc-shaped extension 361y as a starting point, the end facing the straight section 361p with the arc-shaped portion interposed therebetween. A straight extension 361q extends straight toward the outside of the arc-shaped portion of the arc-shaped extension 361y from a substantially intermediate position as a starting point between the straight section 361p and the straight extension 361r on the arc-shaped portion. In this way, the arc-shaped extension 361y illustrated in FIG. 12 is provided with two straight extensions (the straight extensions 361q and 361r). The number of straight extensions provided for each arc-shaped extension may be three or more.

An arc-shaped extension 361z extends from each of the extended ends of the straight extensions 361p, 361q, and 361r. Here, o is the value indicating the position of the part of the high-resistance film layer 32 that overlaps with the arc-shaped extension 361y in the plan view (the value indicating the position when the concentric circular regions are counted in order from the inner side). For example, when the part of the electrode layer 33 overlapping with the arc-shaped extension 361y is the first electrode 333a, o=3, because the part of the high-resistance film layer 32 overlapping with the first electrode 333a is the third high-resistance film 323. The part of the electrode layer 33 overlapping with the arc-shaped extension 361y can be represented as a first electrode 330a. The arc-shaped extension 361z overlaps with a first electrode 33(o+1) a.

In FIG. 12, the straight section 361p is coupled to a first electrode 33(o−1) a via the contact 35x, coupled to the first electrode 33oa via the contact 351, and coupled to the first electrode 33(o+1) a via the contact 350. The arc-shaped extension 361y is coupled to the first electrode 33oa via the contact 35T at the starting point of the straight extension 361q and via the contact 35 at the starting point of the straight extension 361r. The arc-shaped extensions 361z are each coupled to the first electrode 33 (o+1) a via the contacts 350 at opposite end positions of the arc-shaped portion.

In FIG. 12, a base 362m corresponds to the base of the second potential line 362 in FIG. 10. In this way, the shape of the base of the second potential line 362 is not limited to a polygonal shape, and may be an arc shape. The base 362m illustrated in FIG. 12 is also the part corresponding to the part of the first potential line 361 illustrated in FIG. 12.

From the base 362m, an extension 362k extends to the position of a second electrode 33(o−1) b such that part of the extension 362k is aligned substantially parallel to part of the straight section 361p. From the base 362m, an extension 362x extends to the position of a second electrode 33ob such that part of the extension 362x is aligned substantially parallel to part of the straight extension 361q. From the base 362m, an extension 362B extends to the position of the second electrode 33ob such that part of the extension 362B is aligned substantially parallel to part of the straight extension 361r. From the base 362m, extensions 362Γ, 362Δ, and 362Ω each extend from a position substantially facing the extended end of the arc-shaped extension 361z in the radial direction to the position of a second electrode 33(o+1) b.

In FIG. 12, the extension 362k is coupled to the second electrode 33(o−1) b via the contact 353, coupled to the second electrode 33ob via the contact 354, and coupled to the second electrode 33(o+1) b via the contact 350. The extensions 362x and 362ß are each coupled to the second electrode 33ob via the contact 354 and each coupled to the second electrode 33(o+1) b via the contact 350. The extensions 362Γ, 362Δ, and 362Ω are each coupled to the second electrode 33(o+1) b via the contact 350.

There are no straight extensions extending from the arc-shaped extensions 361z in FIG. 12. Another one or more straight extensions, however, may extend outward from the arc-shaped extensions 361z. In other words, from one arc-shaped extension (e.g., arc-shaped extension 361z), which is positioned in the radial direction outside another arc-shaped extension (e.g., arc-shaped extension 361y) and coupled to the other arc-shaped extension with the straight extension interposed therebetween, one or more additional straight extensions may extend outward, and one or more arc-shaped extensions may extend from each of the one or more arc-shaped extensions. The second potential line 362 has the extensions (e.g., the extensions 362k, 362x, 3623, 362T, 3624, and 3622) that extend toward the inside of the light-transmitting region AA such that the extensions are aligned substantially parallel to one or more of the straight extensions at positions where the extensions do not intersect the arc-shaped extensions, corresponding to the branches of the first potential line 361.

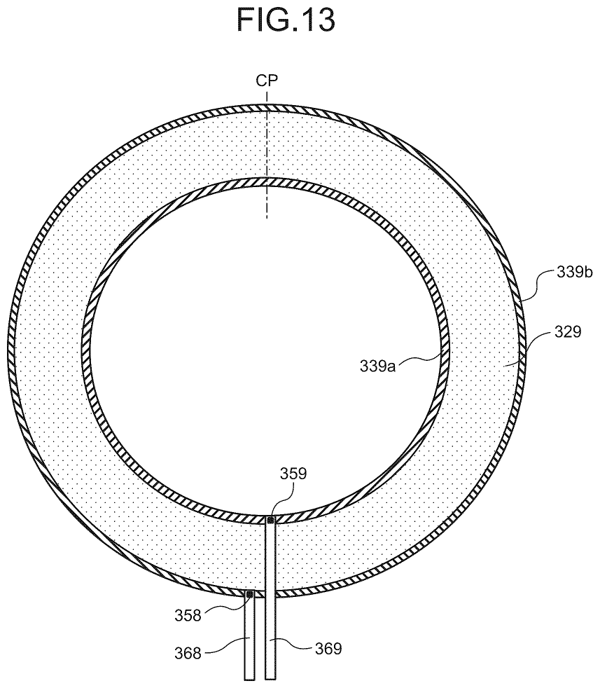

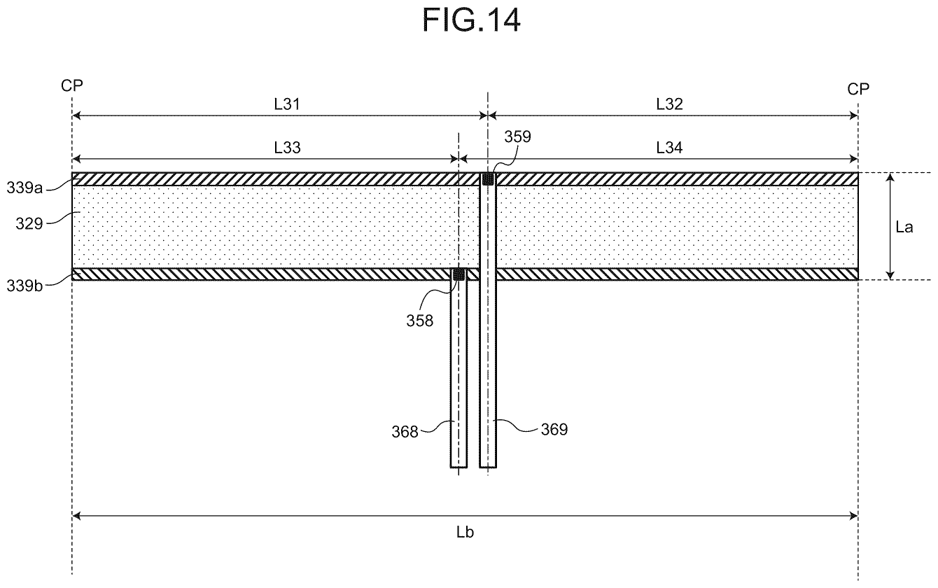

As described above with reference to FIGS. 1 to 12, each of some electrodes of the electrode layer 33 (e.g., the second electrodes 331b, 332b, 333b, etc.) provided in the concentric circular regions is coupled to the second potential line 362 at a plurality of positions via the contacts provided at a plurality of positions of the contact layer 35 while some electrodes of the electrode layer 33 provided in the concentric circular regions (e.g., the first electrodes 332a, 333a, etc.) except the electrode provided at the innermost circumference (the first electrode 331a) are coupled to the first potential line 361 at a plurality of positions. As a result, the refractive index difference described with reference to FIG. 4 can be generated more reliably. The following describes the mechanism and concept of the generation of the refractive index difference with reference to FIGS. 13 and 14.

FIG. 13 is a schematic diagram illustrating a structure in which different potentials are applied to a high-resistance film 329 that has a ring-like shape and is provided with a first electrode 339a on the inner periphery side and a second electrode 339b on the outer periphery side, from a single contact point on the inner periphery side and a single contact point on the outer periphery side. The high-resistance film 329 has the same structure as the high-resistance film layer 32. The first electrode 339a and the second electrode 339b has the same structure as the electrode layer 33. The potentials of the second potential line 368 and the first potential line 369 differ from each other. The potential of the second potential line 368 is applied to the second electrode 339b via the contact 358. The potential of the first potential line 369 is applied to the first electrode 339a via the contact 359. FIG. 14 is a schematic diagram illustrating the high-resistance film 329 illustrated in FIG. 13 in the configuration cut at a cutting position CP and unfolded linearly. In FIG. 14, a width La denotes the width of the high-resistance film 329 in the direction in which the contacts 358 and 359 face each other, and a length Lb denotes the length of the high-resistance film 329 in the direction orthogonal to the width La, that is, the length of the circumference of the high-resistance film 329 in FIG. 13.

In FIG. 14, the length from each of the contact 358 and the contact 359 to the farthest position of the high-resistance film 329 is substantially half of the length Lb. As the distance from a contact (the contact 358 or 359) is increased, the influence of the potential brought by the contact is more likely weakened. Therefore, the potential difference between the potential applied from the second potential line 368 via the contact 358 and the potential applied from the first potential line 369 via the contacts 359 is the lowest near the cutting position CP. As the length Lb becomes longer, lengths L31, L32, L33, and L34 become longer. The potential difference in the direction of the width La at a position near the cutting position CP is lower than the potential difference at a position near the contact 358 or 359.

Suppose that only one contact of the contact layer 35 is provided on each of the inner and outer periphery sides of the concentric circular regions in the liquid crystal panel AA of the liquid crystal panel 10, as the contacts 358 and 359 illustrated in FIG. 13. In this case, among the concentric circular regions in the light-transmitting region AA of the liquid crystal panel 10, the more outer the concentric circular region, the larger the resistance based on the circumferential length of the structural components (e.g., the first electrode 339a, and the second electrode 339b) included in the electrode layer 33.

Therefore, in this case, the more outer the concentric circular region, the more difficult it is to generate a voltage gradient based on the potential difference between the inner and outer periphery sides of the high-resistance film layer 32. This makes it difficult to produce the refractive index difference described with reference to FIG. 4.

In the liquid crystal panel 10 described with reference to FIG. 3, the difference between the potential applied from the first potential line 361 and the potential applied from the second potential line 362 is applied to the liquid crystal 40 via the contact layer 35, the electrode layer 33, and the high-resistance film layer 32.

As described above, the high-resistance film layer 32 has an electrical resistance relatively higher than that of the electrode layer 33. Due to the relatively high electrical resistance, the larger the width of the concentric circular region in the radial direction is, the easier it is to establish a voltage gradient based on the potential difference between the inner and outer periphery sides. However, as illustrated in FIG. 2 and the like, the more outer the concentric circular region, the narrower the width in the radial direction between the inner and outer periphery sides. Thus, the more outer the concentric circular region, the more difficult it is to establish a voltage gradient based on the width of the high-resistance film layer 32 in the radial direction.

In this way, the more outer the concentric circular region, the more technically difficult it is to generate a voltage gradient based on the potential difference between the inner and outer periphery sides and a refractive index difference based on the voltage gradient, in terms of both the length Lc to the cutting position CP and the width in the radial direction of the high-resistance film layer 32. Therefore, in the present disclosure, each of some electrodes of the electrode layer 33 (e.g., the second electrodes 331b, 332b, 333b, etc.) provided in the concentric circular regions is coupled to the second potential line 362 at a plurality of positions via the contacts provided at a plurality of positions of the contact layer 35 while some electrodes of the electrode layer 33 provided in the concentric circular regions (e.g., the first electrodes 332a, 333a, etc.) except the electrode provided at the innermost circumference (the first electrode 331a) are coupled to the first potential line 361 at a plurality of positions.

Specifically, the second electrode 331b is coupled to the second potential line 362 at four positions (at the contacts 351a, 351b, 351c, and 351d). The second electrode 332b is coupled to the second potential line 362 at four positions (at the contacts 352e, 351f, 352g, and 352h). The second electrode 333b is coupled to the second potential line 362 at eight positions (at the contacts 353i, 353j, 353k, 353m, 353n, 353p, 353q, and 353r). This means that the contacts via which the potential of the second potential line 362 is transmitted to each of the second electrodes 331b and 332b can be arranged such that the contacts divide the circumference on the outer periphery side of each of the second electrodes 331b and 332b into four sections. Thus, the length from each contact to the furthest potential arrival point along the circumference on the outer periphery side can be regarded as the length obtained by dividing the circumference on the outer periphery side by 8. This also means that the contacts via which the potential of the second potential line 362 is transmitted to the second electrode 333b can be arranged such that the contacts divide the circumference on the outer periphery side of the second electrode 333b into eight sections. Thus, the length from each contact to the farthest potential arrival point along the circumference on the outer periphery side can be regarded as the length obtained by dividing the circumference on the outer periphery side by 16.

The first electrode 332a is coupled to the first potential line 361 at four positions (at the contacts 352a, 352b, 352c, and 352d). Thus, the length from each contact to the farthest potential arrival point along the circumference on the inner periphery side can be regarded as the length obtained by dividing the circumference on the inner periphery side by 8. The first electrode 333a is coupled to the first potential line 361 at eight positions (at the contacts 353a, 353b, 353c, 353d, 353e, 353f, 353g, and 353h). Thus, the length from each contact to the farthest potential arrival point along the circumference on the inner periphery side can be regarded as the length obtained by dividing the circumference on the inner periphery side by 16. The first electrode 331a is coupled to the first potential line 361 at one position (at the contact 351). The first electrode 331a has a circular shape. Thus, one potential transmission position is enough for potential transmission from the inner periphery side, i.e., the center.

Assume that an effective value of the difference in electrical resistance between the inner and outer periphery sides of the circular or ring-shaped high-resistance film layer 32 in one concentric circular region is a resistance ratio. The resistance ratio is affected by not only the electrical resistance (a first resistance) between the inner and outer periphery sides of the high-resistance film layer 32 caused by the width of the high-resistance film layer 32 in the radial direction (width corresponding to the width La illustrated in FIG. 13) but also the electrical resistance (a second resistance) of the electrode layer 33 depending on the circumferential length of the concentric circular region (corresponding to the length Lb illustrated in FIG. 13) in which the high-resistance film layer 32 is provided. Specifically, the resistance ratio is the value obtained by dividing the first resistance by the second resistance. The resistance ratio needs be greater than 100 and is preferably around 1000. To obtain such a resistance ratio, it tends to be preferable to make the first resistance larger and the second resistance smaller. However, the high-resistance film layer 32 disposed in the outer concentric circular region has a smaller width in the radial direction. This makes it more difficult to ensure the first resistance in the more outer concentric circular region. Therefore, in the embodiment, the multiple contacts that transmit potential from the first potential line 361 and the second potential line 362 are provided to divide the circumference length of the concentric circular region into multiple sections, thereby making the second resistance smaller. As a result, the resistance ratio is ensured.

When the resistance ratio is significantly higher than 1000, sufficient voltage gradient cannot be obtained, which makes it difficult to generate the refractive index difference described with reference to FIG. 4. The resistance ratio is thus preferable around 1000.

As described above, according to the embodiment, the liquid crystal panel 10 includes two substrates (the first substrate 37 and the second substrate 43) and the liquid crystal 40 interposed between the two substrates. The first substrate (the first substrate 37), which is one of the two substrates, includes: the potential gradient forming section (e.g., the first high-resistance film 321, the second high-resistance film 322, the third high-resistance film 323, the fourth high-resistance film 324, etc.), which is provided in the light-transmitting region AA and has the outer periphery edge having a circular shape; the first electrode (e.g., the first electrodes 331a, 332a, 333a, 334a, etc.), which is provided on the inner periphery side of the potential gradient forming section; the second electrode (e.g., the second electrodes 331b, 332b, 333b, 334b, etc.), which is provided on the outer periphery side of the potential gradient forming section and has a ring-like shape; the first transmission section (the first potential line 361) to which one of two different potentials is applied; the second transmission section (the second potential line 362) to which the other of the two potential is applied; the first contact (e.g., one or more of the contacts 351, 352a, 352b, 352c, 352d, 353a, 353b, 353c, 353d, 353e, 353f, 353g, 353h, 354x, 35x, 35T, and 352), which couples the first electrode and the first transmission section; and the second contact (e.g., two or more of the contacts 351a, 351b, 351c, 351d, 352e, 352f, 352g, 352h, 353i, 353j, 353k, 353m, 353n, 353p, 353q, 353r, 354y, 35B, 354, and 350), which couples the second electrode and the second transmission section. The potential gradient forming section made of a conductor having an electrical resistance higher than those of the first and the second electrodes. A plurality of second contacts are provided for the second electrode.

This allows the potential of the second transmission section (the second potential line 362) to be applied on the outer periphery side of the potential gradient forming section (e.g., the first high-resistance film 321, the second high-resistance film 322, the third high-resistance film 323, the fourth high-resistance film 324, etc.) via the second contacts (e.g., two of more of the contacts 351a, 351b, 351c, 351d, 352e, 352f, 352g, 352h, 353i, 353j, 353k, 353m, 353n, 353p, 353q, 353r, 354y, 356, 354, and 350). This makes it possible to more reliably form the potential gradient based on the potential difference between the inner and outer periphery sides of the potential gradient forming section than a case where the potential of the second transmission section is applied to the potential gradient forming section via a single second contact.

The second contacts (e.g., two or more of the contacts 351a, 351b, 351c, 351d, 352e, 352f, 352g, 352h, 353i, 353j, 353k, 353m, 353n, 353p, 353q, 353r, 354y, 35B, 354, and 350) are arranged to divide the ring of the second electrode (e.g., the second electrodes 331b, 332b, 333b, 334b, etc.) into n sections. n is a natural number equal to or larger than two. This allows the length from the second contact to the farthest potential arrival point along the circumference of the ring formed by the second electrode to be the length of the circumference divided by 2n. In other words, the length from the second contact to the farthest potential arrival point along the circumference of the second electrode can be shorter than a case where the potential of the second transmission section (the second potential line 362) is applied to the second electrode via a single second contact. As a result, the potential is more reliably applied to the farthest potential arrival point. This makes it possible to more reliably form the potential gradient based on the potential difference between the inner and outer periphery sides of the potential gradient forming section (e.g., the first high-resistance film 321, the second high-resistance film 322, the third high-resistance film 323, the fourth high-resistance film 324, etc.).

The first electrode includes the ring-shaped electrode having a ring-like shape (e.g., the first electrodes 332a, 333a, 334a, etc.). A plurality of first contacts (e.g., two or more of the contacts 352a, 352b, 352c, 352d, 353a, 353b, 353c, 353d, 353e, 353f, 353g, 353h, 354x, 35x, 35T, and 352) are provided. As a result, the potential of the first transmission section (the first potential line 361) is applied to the ring-shaped electrode via the multiple first contacts. This makes it possible to more reliably form the potential gradient based on the potential difference between the inner and outer periphery sides of the potential gradient forming section (e.g., the first high-resistance film 321, the second high-resistance film 322, the third high-resistance film 323, the fourth high-resistance film 324, etc.) than a case where the potential of the first transmission section is applied to the first electrode via a single first contact.

The first contacts (e.g., two or more of the contacts 352a, 352b, 352c, 352d, 353a, 353b, 353c, 353d, 353e, 353f, 353g, 353h, 354x, 35x, 35T, and 35Q) are arranged to divide the ring of the ring-shaped electrode (e.g., the first electrodes 332a, 333a, 334a, etc.) into m sections. m is a natural number equal to or larger than two. This allows the length from the first contact to the farthest potential arrival point along the circumference of the ring formed by the ring-shaped electrode to be the length of the circumference divided by 2 m. In other words, the length from the first contact to the farthest potential arrival point along the circumference of the ring-shaped electrode can be shorter than a case where the potential of the first transmission section (the first potential line 361) is applied to the ring-shaped electrode via a single first contact. As a result, the potential is more reliably applied to the farthest potential arrival point. This makes it possible to more reliably form the potential gradient based on the potential difference between the inner and outer periphery sides of the potential gradient forming section (e.g., the first high-resistance film 321, the second high-resistance film 322, the third high-resistance film 323, the fourth high-resistance film 324, etc.).

The first transmission section (the first potential line 361) has the arc-shaped section (e.g., any one or more of the arc-shaped extension 361e, 361f, 361g, 361h, 361x, 361y, and 361z) along the ring-shaped electrode (e.g., the first electrodes 332a, 333a, 334a, etc.). The first contacts (two or more of the contacts 352a, 352b, 352c, 352d, 353a, 353b, 353c, 353d, 353e, 353f, 353g, 353h, 354x, 35x, 35T, and 352) couple the arc-shaped section and the ring-shaped electrode. This makes it possible to ensure the coupling portions between the arc-shaped section and the arc-shaped electrode via the first contacts while further reducing the area occupied by the first transmission section in the light-transmitting region AA.

A plurality of ring-shaped electrodes (e.g., the first electrodes 332a, 333a, 334a, etc.) that have different diameters are provided. The first transmission section (the first potential line 361) has the straight extension (e.g., the extensions 361b, 361c, and 361d) that extends straight toward the outer periphery side from the position overlapping with one ring-shaped electrode (e.g., the first electrode 332a) located relatively on the inner periphery side among the ring-shaped electrodes, and the arc-shaped extension (e.g., the arc-shaped extensions 361e, 361g, and 361h) that extends from the straight extension along another ring-shaped electrode (e.g., the first electrode 333a) located on the outer periphery side of the one ring-shaped electrode among the ring-shaped electrodes. The first contacts couple the arc-shaped extension and the other arc-shaped electrode. This makes it possible to ensure the coupling portion between the arc-shaped extension and the ring-shaped electrode located on the outer periphery side of the ring-shaped electrode located relatively on the inner periphery side among the ring-shaped electrode via the first contacts while further reducing the area occupied by the first transmission section in the light-transmitting region AA.

The second transmission section (the second potential line 362) includes the base surrounding an outer edge of the light-transmitting region AA and the extension (e.g., the extensions 362a, 362b, 362c, 362d, 362e, 362f, 362g, 362h, 362p, 362q, 362r, 362s, 362t, 362u, 362v, 362w, 362x, 362y, 362z, 362j, 362x, 362B, 362, 3624, and 3622) extending from the base into the light-transmitting region AA. The second contacts (e.g., two or more of the contacts 351a, 351b, 351c, 351d, 352e, 352f, 352g, 352h, 353i, 353j, 353k, 353m, 353n, 353p, 353q, 353r, 354y, 35ß, 354, and 350) couple the extension and the second electrode (e.g., the second electrodes 331b, 332b, 333b, 334b, etc.). This further makes it possible to ensure the coupling portion between the extension and the second electrode via the second contacts while further reducing the area occupied by the first transmission section in the light-transmitting region AA.

The circular electrode (the first electrode 331a) is provided in the light-transmitting region AA. This makes it possible to fully cover the innermost circumference of the light-transmitting region AA, the innermost circumference being capable of functioning as a circular Fresnel lens.

The second substrate (second substrate 43), which is the other of the two substrates, is provided with the common electrode 42 that is provided to cover the light-transmitting region AA and faces the potential gradient forming section (e.g., the first high-resistance film 321, the second high-resistance film 322, the third high-resistance film 323, the fourth high-resistance film 324, etc.) with the liquid crystal 40 therebetween. The liquid crystal 40 is controlled such that the refractive index of the light-transmitting region AA with respect to light entering the light-transmitting region AA along the direction (third direction Dz) in which the two substrates face differs between the inner and outer periphery sides of the gradient forming section depending on the potential gradient generated in the potential gradient forming section based on the potential difference between the potential from the first transmission section (the first potential line 361) and the potential from the second transmission section (the second potential line 362). This allows the light-transmitting region AA to function like a lens.

The liquid crystal panel 10 of the embodiment is an electrically controlled birefringence (ECB) liquid crystal panel. Therefore, the direction of initial orientation determined by the orientation film 41 and the direction of initial orientation determined by the orientation film 31 are parallel to each other in the plan view and have an anti-parallel relation. The specific aspects of the liquid crystal panel 10, such as the features of the orientation films 31, 41, etc. are only examples. The present disclosure does not limit the form of the liquid crystal panel to those of the examples. Within the form of the claims, the specific form of the liquid crystal panel can be modified as needed.

It should be understood that the present disclosure provides any other effects achieved by aspects described above in the present embodiment, such as effects that are clear from the description of the present specification or effects that could be thought of by the skilled person in the art as appropriate.

What is claimed is:

1. A liquid crystal panel comprising:
two substrates; and
a liquid crystal interposed between the two substrates, wherein
a first substrate that is one of the two substrates includes:
a potential gradient forming section that is provided in a light-transmitting region and has an outer periphery edge having a circular shape;
a first electrode that is provided on an inner periphery side of the potential gradient forming section;
a second electrode that is provided on an outer periphery side of the potential gradient forming section and has a ring-like shape;
a first transmission section to which one of two different potentials is applied;
a second transmission section to which the other of the two different potentials is applied;
a first contact that couples the first electrode and the first transmission section; and
a second contact that couples the second electrode and the second transmission section,
the potential gradient forming section is made of a conductor having an electrical resistance higher than electrical resistances of the first electrode and the second electrode, and
a plurality of the second contacts are provided for the second electrode.

2. The liquid crystal panel according to claim 1, wherein
the second contacts are arranged to divide a ring of the second electrode into n sections, and
n is a natural number equal to or larger than two.

3. The liquid crystal panel according to claim 2, wherein
the first electrode includes a ring-shaped electrode having a ring-like shape, and
a plurality of the first contacts are provided for the ring-shaped electrode.

4. The liquid crystal panel according to claim 3, wherein
the first contacts are arranged to divide a ring of the ring-shaped electrode into m sections, and
m is a natural number equal to or larger than two.

5. The liquid crystal panel according to claim 4, wherein
the first transmission section has an arc-shaped section along the ring-shaped electrode, and
the first contacts couple the arc-shaped section and the ring-shaped electrode.

6. The liquid crystal panel according to claim 5, wherein
a plurality of the ring-shaped electrodes that have different diameters are provided,
the first transmission section has a straight extension that extends straight toward the outer periphery side from a position overlapping with one ring-shaped electrode located relatively on the inner periphery side among the ring-shaped electrodes, and an arc-shaped extension that extends from the straight extension along another ring-shaped electrode located on the outer periphery side of the one ring-shaped electrode among the ring-shaped electrodes, and
the first contacts couple the arc-shaped extension and the other ring-shaped electrode.

7. The liquid crystal panel according to claim 1, wherein
the second transmission section includes a base surrounding an outer edge of the light-transmitting region and an extension extending from the base into the light-transmitting region, and
the second contacts couple the extension and the second electrode.

8. The liquid crystal panel according to claim 1, wherein a circular electrode that is the first electrode is provided in the light-transmitting region.

9. The liquid crystal panel according to claim 1, wherein
a second substrate that is the other of the two substrates is provided with a common electrode that is provided to cover the light-transmitting region and faces the potential gradient forming section with the liquid crystal therebetween, and
the liquid crystal is controlled such that a refractive index of the light-transmitting region with respect to light entering the light-transmitting region along a direction in which the two substrates face differs between the inner and outer periphery sides of the gradient forming section depending on a potential gradient generated in the potential gradient forming section based on the potential difference between the two different potentials.
